(19) United States
(12) Patent Application Publication
(10) Pub. No.: US 2004/0030644 A1
(43) Pub. Date: Feb. 12, 2004

(54) Systems for facilitating card processing systems/improved risk control

(76) Inventor: Stephen J. Shaper, Houston, TX (US)

Correspondence Address: SUE Z. SHAPER, P.C., 1800 WEST LOOP SOUTH, SUITE 750, HOUSTON, TX, 77027, US

(21) Appl. No.: 10/433,914

(22) PCT Filed: Dec. 14, 2001
(86) PCT No.: PCT/US01/48700

(51) Int. Cl. G06F 17/60

(52) U.S. Cl. 705/39

(57) ABSTRACT

A method for facilitating charge card transactions including evaluating electronically transmitted data relating to a charge card transaction and guaranteeing a charge card transaction that meets certain criteria against risk of loss.

This invention is related to and is a continuation of and claims priority based on U.S. Ser. No. 60/256,728 filed Dec. 18, 2000.

### FIELD OF THE INVENTION

The invention relates to financial transactions, and more particularly to systems for facilitating card-based financial transactions with improved risk control

### BACKGROUND OF THE INVENTION

In the sector of the financial transaction industry dealing with the processing and clearing of checks and/or bank drafts, a system for controlling risk for a merchant by check guarantee developed. The banking system, as a general rule, does not provide recipients of a draft on a demand deposit account with a ready ability to check whether there are funds sufficient in an account to cover the draft. Nor, as a general rule, do banks provide merchants with an ability to place a hold on funds upon the acceptance of a draft. As between the merchant and the bank, the risk of insufficient funds in the account to cover the check falls on the merchant. In the case of stolen checks and falsified signatures, if the bank catches the forgery within an established time, the merchant also bears the risk of loss.

To increase the volume of financial transactions for merchants and control risk, check guarantee entities arose, entities independent of a depositor's bank and, analogously with the merchant, without general access to information at a depositor's bank in regard to the status of accounts or any ability to place a hold on funds. These entities, based upon their own data bases and statistical histories, guarantee checks for merchants. The guarantee service providers, for a predictable fee, estimate the chances of sufficient funds being in accounts at time of arrival of the physical check at the bank for processing for checks that are presented to their merchants for acceptance. They also estimate the genuineness of the check and/or the willingness of the drafter to cover the check. Typically, if a check is approved by the service and then it is rejected by a bank, the guarantee service pays the merchant for the check and pursues its own collection processes, to the extent possible.

The credit and debit card industries (together with smart cards and/or chip cards referred to generically herein as “charge cards”) developed with different risk control procedures and allocations. In the charge card industry, card issuing banks, or their surrogates, are consulted for approval by the merchant prior to the merchant's acceptance of a charge on a card. Issuing banks (or the like, understood to include novel financial units or bodies) can determine whether there are sufficient funds or credit in a cardholder's account (understood to include chips and/or a variety of traditional and/or novel “accounts”) and place a hold on these funds. If sufficient funds or credit is deemed available by the issuing bank and the transaction is approved, a hold is placed on those funds or credit. When a card is presented and the issuing bank (or its surrogate) is contacted and approves the transaction, the bank then assumes the risk of nonpayment. For the facilitating of financial transactions and acceptance of this risk, the merchant is charged a predetermined fee.

(If a cardholder subsequently disputes a charge, and usually only when a card was presented, the issuing bank or a member of the card transaction clearing service will investigate. The merchant generally will only bear a loss upon genuine cardholder claims in regard to an improper delivery of the goods or services. This is referred to as a chargeback and is not related to whether or not the cardholder pays or eventually pays the issuing bank.)

(The issuing bank or its surrogate agents may employ services to predict whether a presenter of a card is genuine cardholder, since the issuing bank in general bears the loss for approved transactions on lost or stolen or forged cards.)

In the charge card system when the physical card is not presented by the purchaser but rather card information is presented orally or electronically or the like, the risk of loss for nonpayment generally shifts. In the case of the physically non-presented card, risk of loss from nonpayment significantly shits to the merchant. The merchant can be “charged back” for non payments in a significant number of circumstances.

Merchants, to help reduce their “chargebacks” in the change card system, especially when a physical card is not presented, such as for transactions over the phone or over the Internet, have developed systems themselves or have employed outside services to preview transactions to detect for fraud or past non-payment. This preview is sometimes referred to as scrubbing or screening. Scrubbing or screening typically involves checking a database of known fraudulent cards or high risk scenarios. It could involve sophisticated algorithms or other mathematical or statistical calculations. Transactions may be scored and a merchant can determine for itself which scores it will accept or decline.

To add a further complication for the merchant and a further incentive to scrub, Mastercard, Visa and the like, associations of banks or other organizations that issue cards, set regulations in regard to card usage. One such regulation may limit a percent of “chargebacks” that a merchant can sustain and continue to be allowed to accept the cards of that association. A limit might be set at one percent or three percent of all charged amounts. Such limits reflect the fact that declined payments by a cardholder, even though the merchant may eventually bear the risk of loss, typically represent time and effort that must be spent by an issuing bank (or its surrogate or the association) to sort out and determine whether there are legitimate reasons for the decline, or whether legitimate goods and services were actually delivered to the cardholder, whether a chargeback is justified and where lies the proper liability therefore, and/or whether a cardholder should be terminated.

In some industries, such as in sales of goods and services over the Internet, chargebacks have a tendency to rise well over the preferred limits of card associations. Such provides an incentive for merchants and/or their surrogates to attempt to independently predict up front likely chargebacks and decline those transactions in advance.

The instant invention discloses a further innovation in the charge card industry, a service that appears contradictory to standard operating procedures in the industry, a service that appears upon the surface not to be necessary at all in the charge card world. Historically in the charge card world an issuing bank can determine up front the sufficiency of funds/credit in an account and place a hold on the funds or credit prior to approving or disapproving each transaction. Unexpectedly, the instant invention discloses a guarantee service for charge cards.

The guarantee service is particularly pertinent to the use of charge cards in the situation when a card is not physically presented. The instant invention discloses a system, a service and a provider that will, as in the check draft world, guarantee approved transactions. Transactions that the guarantor approves, typically for the merchant, are guaranteed against “chargebacks” to a merchant (or at least against certain “chargebacks”.) Thus, the risk of chargebacks on guarantor approved card transactions can be passed to the guarantor, for a fee, preferably a quite predictable fee.

Typically the guarantor guarantees against cardholder non-payment due to fraudulent card (lost, stolen, counterfeit) and/or fraudulent claims of non-delivery or inadequate delivery of goods and services. Contracts between a service provider and the merchant would typically not guarantee payment of chargebacks for legitimate complaints in regard to the quality of goods and services delivered.

By servicing a plurality of merchants such a guarantor can be in position to better estimate and/or predict a risk of chargeback, can develop superior databases and algorithms and can spread the risk over a broader base of transactions. As an advantage to a merchant, the instant invention promises to permit a management of risk and a greater percentage of transactions to be approved while lowering a merchant's total chargeback cost and the potential loss of ability to accept certain types of cards because of excessive chargebacks, thereby generating greater sales, predictable costs and lower overall costs. The fee paid for a guarantee to cover all chargebacks is preferably a predictable amount, removing the risk of wide variations in losses in the business.

The instant invention has further advantages. The guarantor service, most likely in return for a fee from a banking or card network, could optionally guarantee chargebacks in situations where a merchant is in collusion with a customer. In such cases the bank or card system ultimately bears the risk of loss, because no chargeback is possible in regard to the merchant. The guarantor provider of the instant invention could also optionally, in return for a fee, assume the job of determining proper outcomes in the cases of the disputed delivery or provision of goods and services, as between the merchant and a customer. Issuing banks and their surrogates may well find the guarantor more efficient and cost effective in resolving such disputes.

The instant invention also has application in cases where a physical card is presented. In the case of stolen cards, or in the case of disputed goods and/or service claims that are bogus, the guarantor for a fee may directly or indirectly alleviate the risks of a bank who would ultimately bear the loss in such situations.

### SUMMARY OF THE INVENTION

The instant invention includes a method for facilitating charge card transactions comprising evaluating electronically transmitted data (including over the Internet and the like) relating to a charge card transaction and guaranteeing a charge card transaction that meets certain criteria. The guarantee is preferably against risk of loss to a merchant. In certain circumstances a guarantee could be against risk of loss to an issuing bank or members of a card processing system. The charge card is typically a credit card or a debit card, but could be a smart card or chip card also. The method is regarded as particularly valuable in transactions when a card is not physically presented. Preferably a predictable fee will be charged, typically to a merchant. It is envisioned that the guaranteeing can include paying chargebacks on behalf of a merchant to a processing system. Such paying chargebacks might occur upon a pre-notification of a customer dispute. Preferably the guarantee service would receive an assignment of collection rights upon payment of a chargeback such as the merchant's ownership rights for collection purposes. Typically determining whether a charge card transaction meets certain criteria would include reviewing a negative database and/or reviewing a positive database and/or application of rules to transaction data and/or application of an estimation system including algorithms based upon historic transaction data.

### BRIEF DESCRIPTION OF THE DRAWINGS

A better understanding of the present invention can be obtained when the following detailed description of the preferred embodiment is considered in conjunction with the following drawings, in which:

FIG. 1 illustrates typical transactions between a customer, merchant, guarantee service providers, processor, merchant bank, issuing bank and card association, in accordance with one preferred embodiment of the instant invention.

FIG. 2 illustrates alternate modes for the execution of the guarantee of a service provider in a preferred embodiment of the instant invention.

FIG. 3 illustrates a possible collection procedure of a preferred embodiment of the present invention.

### DETAILED DESCRIPTION OF PREFERRED EMBODIMENTS

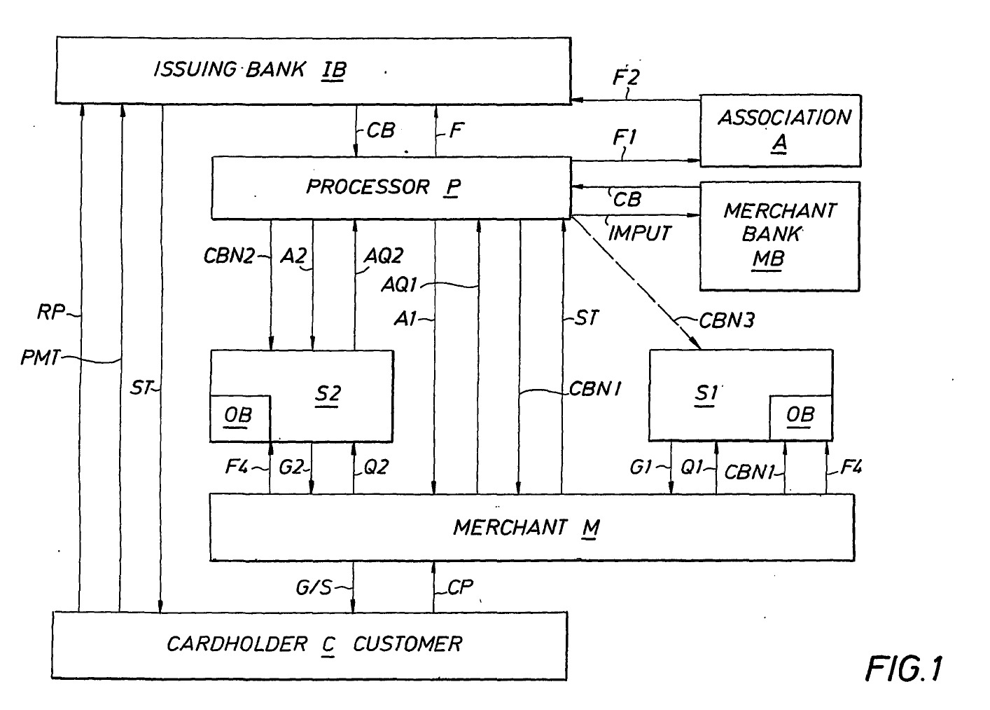

FIG. 1 illustrates transactions of preferred embodiments of the instant invention. Purported cardholder/customer C proposes a charge card transaction CP to merchant M in return for goods and services G/S. (Merchant M may be the “merchant of record” for the card processing system. Alternately, merchant M may contract with a service provider S2 who stands in the place of the merchant as a merchant-of-record for the card processing system.) In the system of FIG. 1 both alternatives are illustrated. Typically only one alternative would exist for any one transaction or merchant. The service provider, S1 or S2 of FIG. 1, can interface only with the merchant or can interface between the merchant and at least a portion of the card processing system, generally illustrated in FIG. 1 as comprising processor P, issuing bank IB and card associations. In the system illustrated in FIG. 1, S2 might even be regarded by processor P as the merchant-of-record. Alternate system provider illustrated as S1 in FIG. 1 may be independent of and have no direct contact with the merchant card processing systems. System provider S1 simply provides guarantee services to merchant M who would most likely be regarded as the merchant-of-record in the transaction.

In regard to the guarantee service illustrated in FIG. 1, a merchant sends transaction information to service provider S1 or S2, illustrated by the form of a query Q₁ or Q₂. The transaction information can include information not only about the transaction and about the merchant but also about the customer or card user. This information about the customer may be secured at the time of the transaction and/or the merchant may have previously secured information about the customer and have stored such information for subsequent use, possibly securing the information from prior transactions or possibly in anticipation of the instant transaction.

System provider S1 or S2 would also likely have an independent database DB concerning transactions, cardholders and merchants. System provider S1 or S2 would analyze the transaction, typically utilizing specialized algorithms and other mathematical and/or statistical methods, and determine whether to approve and guarantee the transaction for the merchant, taking into account a merchant's contract and agreed fees payment schedule. The determination of whether to guarantee may depend upon a particular contract with a merchant including levels of risk and fee structure.

Preferably, either the merchant or the service provider would seek standard approval for the transaction through the usual charge card processing network. The guarantor would preferably not guarantee against a cardholder's subsequent mere inability (or unwillingness) to pay a legitimate undisputed transaction. Collecting such payment and managing such risk is historically the role of the bank or the like. Typically, a standard approval query AQ₁ or AQ₂ for the transaction would go to card processor P that performs processing and settling transactions for issuing banks IB. The card processor determines such factors as whether the card and/or number is likely genuine and whether funds or credit remain in the account to cover the charge and whether the card appears to be lost or stolen. The card processor communicates with issuing banks, either contemporaneously or from time to time, in order to be able to determine some or all of this information. Approval A₁ or A₂ (or alternately disapproval) is returned either to system provider S2 or the merchant.

Given an approval the merchant transfers the goods or services G/S to the customer C and sends the charge information on the transaction to the card processor, usually in a settlement transmission ST at the end of the day. At the end of the day, or at some period of time, the processor settles transactions. Money MPMT is credited to a bank account of the merchant-of-record in the merchant's bank MB. The money payment may deduct a standard fee charged to the merchant for processing the transaction. A transmission D to the issuing bank instructs that the proper charge card account be debited.

Upon receipt of a statement ST (or the like) from the issuing bank IB, a customer C either accepts the charges and pays PMT or undertakes to cover the transaction with money PMT, as appropriate, or possibly declines RP to pay for part or all of the transactions reflected on statement ST. With debit cards C has already paid and either accepts or disputes. A customer might refuse or decline to pay for a transaction for two general legitimate reasons. On the one hand, a customer may declare that the transaction was not genuine, was not a transaction of the cardholder. On the other hand, a customer might complain that the goods and services were not delivered or were defective. Both declines of payment by a customer might result in a “chargeback” to the merchant in the system.

If the card was presented to the merchant and the system approved the transaction, the issuing bank generally bears the loss when the charge was not genuine, that is, when the charge did not originate from the genuine cardholder. If a customer's decline of payment RP was for goods and services purportedly defective or not delivered, the issuing bank or its processor attempts to determine whether the merchant should bear this loss because the goods and services were in fact defective in some way or whether the customer is dissembling. The procedures involved for the issuing bank or the processor to resolve those disputes and determine legitimate “chargebacks” to the merchant is time consuming. For such reasons measures are typically instituted to limit the number or percent of chargebacks in the system.

In the case in which a card was not physically presented by a customer to a merchant, the merchant generally must pay a chargeback associated with a cardholder's refusal to pay RP, whether the refusal is bogus or genuine. The merchant's bank account will be debited for the amount of the chargeback by the processor, indicated by payment CB illustrated running between the merchant's bank to the processor. (Of course, the issuing bank and/or the transaction clearing system ultimately bears the loss if the merchant by this time cannot refund the money, if the merchant's account is no longer good for the money, and the customer cannot or will not pay.)

Also shown for interest in FIG. 1 is that card associations like Visa, Mastercard and the like typically receive a fee F₁ from a card processor for every transaction. This fee will typically be a percent of the fee charged the merchant. A further percent of that fee F₂ is typically passed on to issuing banks IB.

FIG. 1 illustrates processor P sending a chargeback notice CBN1 and/or CBN2 and/or CBN3, or a “pre-notice”, also indicated by arrows CBN1 and/or arrows CBN2 and/or CBN3, to server S1, server S2 and/or merchant M. Upon receipt of such notice or pre-notice by a server from a processor or merchant, guarantor server S1 or S2, as a condition of the guarantee service, can pay the chargeback for the merchant. Preferably S1 or S2 receives whatever collection rights might exist in regard to the transaction in exchange. In return for the guarantee service the merchant pays server S1 or S2 a fee F4.

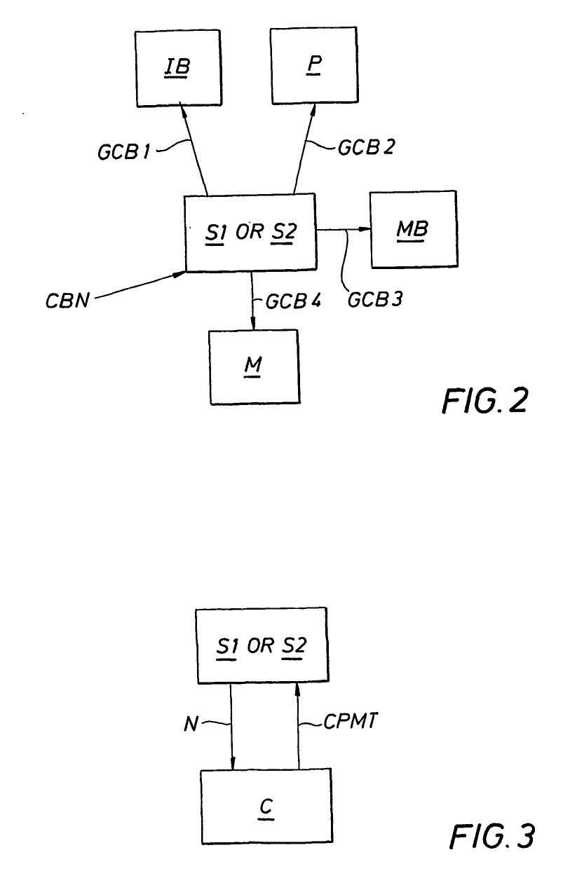

FIG. 2 illustrates how upon receival of a chargeback notice CBN or a chargeback pre-notification CBN server S1 or S2 would pay the guaranteed chargeback on behalf of the merchant. The payment could take a variety of paths such as to the merchant, to the merchant's bank, to the processor or to the issuing bank, illustrated by guaranteed chargeback arrows GCB1, GCB2, GCB3 and GCB4.

FIG. 3 illustrates that the server S1 or S2 would acquire rights from the merchant and/or the processor or issuing bank to pursue payment from the cardholder C when possible. FIG. 3 illustrates server S1 or S2 negotiating, indicating by arrow N, with customer C and potentially C making some payment to server S1 or S2 indicated by arrow CPMT.

Issuing banks and/or the processing system might contract with a service provider to assist in resolving part or all disputed payments from customers, whether or not a card was presented. The issuing banks processors or processing system, directly or indirectly, would cover the cost to the guarantor server for this service. Issuing banks, processors or the processing system might also, directly or indirectly, bear the cost for the guarantor service to guaranty the risk of loss from merchants in collusion with cardholders. In the situation where a merchant is in collusion with a cardholder, there may be no funds of the merchant or the merchant's bank account to pay for the chargeback, resulting in the bank bearing the ultimate risk in loss. The service providing guaranty might also, for a fee, assume the risk of such losses for the bank.

The foregoing disclosure and description of the invention are illustrative and explanatory thereof, and various changes in the size, shape, and materials, as well as in the details of the illustrated system may be made without departing from the spirit of the invention. The invention is claimed using terminology that depends upon a historic presumption that recitation of a single element covers one or more, and recitation of two elements covers two or more, and the like.

It is claimed:

1. (Amended) A method for facilitating charge card transactions, comprising:
evaluating electronically transmitted data directly or indirectly from a merchant relating to a charge card transaction; and
guaranteeing, by a third party distinct from the merchant and charge card issuer, a charge card transaction involving a card not present and meeting certain criteria, against risk of loss to the merchant.

2. (Amended) The method of claim 1 wherein the risk of loss includes a risk of loss by chargeback to the merchant.

3. The method of claim 2 wherein the evaluating is carried out by an entity distinct from the merchant.

4. The method of claim 1 wherein the charge card is a credit card.

5. The method of claim 1 wherein the charge card is a debit card.

6. (Amended) The method of claim 1 that includes guaranteeing a merchant against risk of loss by virtue of a chargeback caused by cardholder denial of participation in a transaction and/or dissatisfaction with goods/services purchased.

7. (Amended) The method of claim 1 that includes establishing a contract with a merchant and guaranteeing charge card transactions for a predictable fee to the merchant.

8. (Amended) The method of claim 2 wherein guaranteeing includes paying a chargeback on behalf of a merchant to a processing system.

9. (Amended) The method of claim 2 that includes paying chargebacks on behalf of a merchant upon pre-notification of a customer dispute.

10. The method of claim 8 that includes receiving an assignment of collection rights upon payment of a chargeback.

11. The method of claim 1 wherein meeting certain criteria is determined by at least one of reviewing a negative database, reviewing a positive database, application of rules to transaction data and application of a chargeback estimation system including at least one algorithm based upon historic transaction data.

12. The method of claim 1 that includes accessing at least one database.

13. (Amended) The method of claim 2 including,
upon a chargeback, assuming by the third party the rights of the merchant vis a vis a charge card holder.

14. The method of claim 13 including,
contacting the customer by the third party to negotiate a payment.

15. (Amended) A method for facilitating charge card transactions, comprising:
evaluating electronically transmitted data directly or indirectly from a merchant relating to a charge card transaction; and
guaranteeing, by a third party distinct from the merchant and charge card issuer, a charge card transaction that meets certain criteria against risk of loss from a merchant non-payment of a chargeback.

16. The method of claim 15 that includes assuming the rights of the card issuer vis a vis the merchant.

17. The method of claim 16 including contacting the merchant by the third party to negotiate a payment.
